(19) United States
(12) Patent Application Publication
(10) Pub. No.: US 2014/0099703 A1
(43) Pub. Date: Apr. 10, 2014

(54) Capillary Waveguide Cuvette

(71) Applicant: William P Parker, (US)

(72) Inventor: William P Parker, (US)

(21) Appl. No.: 13/645,513

(22) Filed: Oct. 5, 2012

(51) Int. Cl. G01N 21/03

(52) U.S. Cl. CPC G01N 21/03
USPC 435/287.9; 356/246; 435/288.7; 216/24; 264/162; 264/400; 264/401; 264/241

(57) ABSTRACT

A cuvette for use with a spectophotometer having a capillary sample chamber having a volume of from 1 microliter to 1 femtoliter.

### CROSS-REFERENCE TO RELATED APPLICATIONS

This application claims priority of U.S. Provisional Application Ser. No. 61/542809 “Nano-cuvette” filed Oct. 4, 2011.

### BACKGROUND OF THE INVENTION

This invention relates to cuvettes for containing ultra small samples in spectrophotometers for examination of their optical characteristics.

A significant utility is to be found in the analysis of very small volume samples using various methods of optical spectroscopy. This is particularly true in the case of biochemical analysis, pharmaceutical screening, forensics and medical diagnostics.

Efforts to understand single cell function require working with samples that are less than a nanoliter, which cannot be done today using existing cuvettes which generally have a sample volume in the ranges of a few hundred nanoliters to a few milliliters. In some medical diagnostic applications, particularly in cancer detection and tumor characterization, small numbers of cells or nucleic acids are harvested during a biopsy procedure making the available samples minute but highly valuable. Some commercially available cuvettes can use samples as small as a few microliters, but these are too large for many small sample applications.

A recent development in spectroscopic analysis utilizes a technique that dispenses with a cuvette or other container for the sample and utilizes the capillary containment of a single droplet of sample caught between two fiber optic containing surfaces which in turn send illumination into the sample and collect the light for spectralanalysis. One such droplet sample spectroscopic instrument is the NanoDrop 2000 produced by Thermo Fisher Scientific. A deficit of the droplet-based approach is that the path length is limited to the distance a droplet can be stretched while between two surfaces, which is approximately 1 mm. Another deficit is that the minimum sample volume required for the instrument is approximately 0.25 microliters. Another non-cuvette based instrument utilizes a specially designed pipette tip to hold a small sample and place it in the analysis region of a spectroscopic instrument, i.e. the PicoDrop produced by General Electric. This approach also has a short path defined by the diameter of the pipette tip and limited to approximately 2 mm.

One object of this invention is to extend the utility of current spectroscopic instruments to the analysis of sample volumes smaller than currently possible with existing cuvettes and other sample holders.

Another object of the invention is to provide droplet based instruments with the capability to measure samples with a lower concentration that currently possible and with smaller sample volumes by means of a longer path length.

An obvious advantage of the instant invention is that a small sample can be contained in a capillary waveguide which simultaneously concentrates the light into a small diameter path which increases the signal to noise ratio and also provides for a long path length which increases the signal level.

The details described here consider currently practiced methods but it is obvious to one skilled in the art that it can also be used to develop new methods of analysis that were not previously considered or invented because there was no viable method to utilize the ultra small volume of samples enabled by this method.

### SUMMARY OF THE INVENTION

The functional concept of the invention is to use the light propagating through a waveguide to optically probe a low volume sample placed therein and measure specific optical characteristics of the sample as a method of analysis. The utility of the device is that it enables the examination and measurement of relevant characteristics of very small samples. Applications of the invention range broadly, from DNA analysis and environmental monitoring to the real-time examination of single cell metabolism. For the purpose of loading a sample into the waveguide and providing a small sample volume it is configured as a capillary tube with a length substantially greater than its diameter. In order to have improved capillary draw of a sample, the interior surface of the capillary waveguide can be chemically or mechanically treated in order to make it hydrophilic, i.e. oxygen plasma treatment. Coatings can be placed on this surface to enhance the performance of the waveguide such as a reflective layer, a light frequency selective layer. The interior surface can be treated to enhance sample interaction such as a coating that is selective to specific molecules, i.e. certain nucleic acids, or the shape or orientations of specific molecules, i.e. functional components of enzymes or sequences of specific DNA molecules.

These and other features of the invention will be more fully described in the following more detailed description

### BRIEF DESCRIPTION OF THE SEVERAL VIEWS OF THE DRAWINGS

FIG. 1A is an isometric view of a cuvette of the invention showing a serpentine sample chamber running from top to bottom.

FIG. 1B is a cross-sectional view showing the placement of the capillary in the top and bottom halves of the cuvette.

FIG. 1C shows an alternative placement of the capillary in only the bottom half of the cuvette.

FIG. 1D is an alternative embodiment of the cuvette in FIG. 1C.

FIG. 1E is an isometric view of a second alternative embodiment of the cuvette in FIG. 1A using reflecting surfaces to allow more compact pathlength,

FIG. 2A is an isometric view of a second embodiment of the cuvette of the invention.

FIG. 2B is a sectional view of an alternate technique for forming a channel formed in a thin layer between two flat plates.

FIG. 2A is a cross-sectional view of another embodiment of the invention including an air vent to allow the expulsion of any air bubbles present in a sample.

FIG. 2B is an enlarged view of the detail of<>the sample chamber of the cuvette of FIG. 2A.

FIG. 3A is a cross-section of yet another embodiment of the invention including a bladder useful to suck samples into the cuvette or to expel a sample.

FIG. 3B is a side sectional view of the cuvette of FIG. 3A.

### DETAILED DESCRIPTION OF THE PREFERRED EMBODIMENTS

The sample can be a liquid, gel, gas or other substance which allows the light to traverse the length of the waveguide while having an interaction with it. An illumination source is placed at one end of the capillary waveguide and a light detection means is placed at the other end in order to facilitate measurement of the interaction of the light entering the waveguide with the sample inside the waveguide. In interacting with the light propagating in the waveguide, the contained sample can absorb, scatter, fluoresce, or generate specific wavelengths in response to the wavelength or intensity of the illumination or perform any of these functions in a manner that is selective spectrally or specific to the sample or the presence or concentration of a specific constituent of the sample.

The volume of the sample is characteristically<>between a few femtoliters (10×⁻16 liter) and a few microliters (10×⁻⁶ liter).

In one embodiment of the invention the capillary tube is less than 100 microns (1×⁻⁴ meter) in diameter and the length is greater than 1 mm.

The light source can be a narrow band source like a laser, tuned to a specific wavelength or wavelengths by spectrally selective means like a diffraction grating or an interference filter, or can be a broad band source like a xenon flash lamp. For applications that are specific to one wavelength of light, i.e. a molecular probe's (dye) fluorescence, the detector can be a single wavelength detector such as a photodiode or photomultiplier tube with a wavelength selective filter between it and the light exiting<>the waveguide. For spectroscopic applications, such as DNA quantitation, the detector can be a combination of a device for generating a spectrum of the light such as a diffraction grating, tunable filter or prism, and the detector can be a light sensitive device or medium such as a photodiode array, angle or position scanned photomultiplier, photographic film or other means of extracting spectrally resolved information from the light exiting the sample region.

One embodiment of the invention that is specific to small samples is a micro-fluidic chip, entirely fabricated from plastic and containing the following elements: a sample input port that leads to a 100 micron diameter by 10 mm long Teflon AF lined capillary waveguide region, a means to allow air to exit the capillary waveguide as the sample enters, an input light guide for bringing illumination to the one end of the capillary, an output light guide that collects light at the opposite end of the capillary and a means to couple to the two light guides respectively to a source of illumination and a light detector.

The sample device maybe produced as a single part or multi-part body using micromachining methods such as milling, injection molding, stamping or other common means from a polymer material i.e. acrylic plastic with an index of refraction of approximately 1.49. The illumination and detection waveguides can be produced by first producing channels or grooves in the device and then filling in these grooves using a material with an index of refraction higher than the acrylic such as EpoTek 301-2 two part epoxy with an index of refraction of approximately 1.53. If made in two parts these channels can be filled with the liquid epoxy which is then cured and in subsequent machining steps the surface is machined flat and a new groove introduced for the sample region. A second cover part is then adhered to the first part in order to enclose the sample region. For use with aqueous samples the waveguide sample region requires a cladding, coating or a wall region that has an index of refraction lower than water's at approximately 1.33. In order to contain the illumination and allow the maximum amount of light to traverse the sample the wall of the capillary waveguide sample region is made from a material with a sufficiently low index of refraction such as Teflon AF (index of refraction 1.31). An alternative method is to coat the walls of the sample region with a reflective metal such as aluminum.

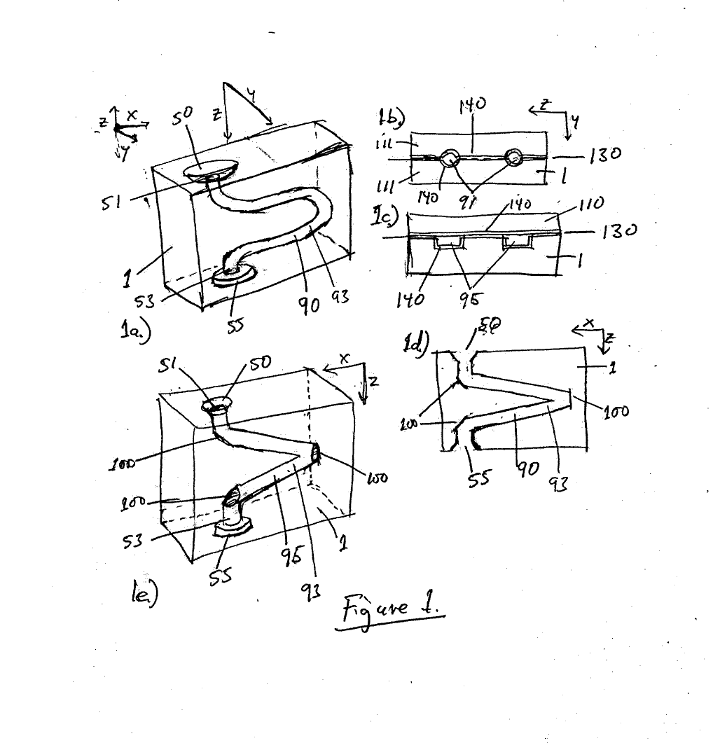

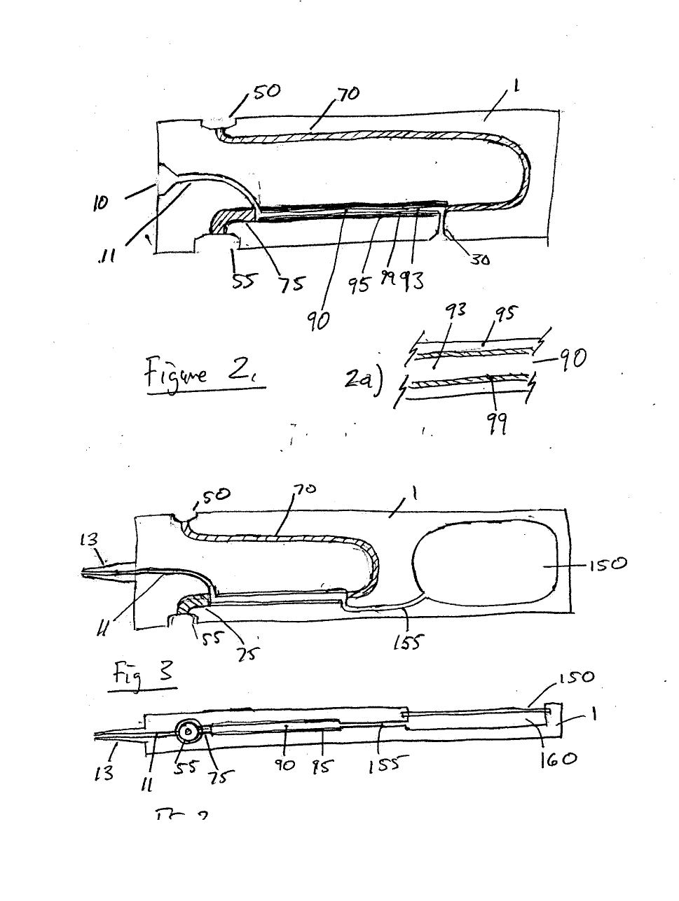

In this embodiment the light guides need not be collinear or coaxial with the capillary since they can route light around a radius. The light guides and waveguide regions can be any cross section including circular or rectangular. See FIG. 1A.

In the above embodiment the input and output light guides are separated from the capillary waveguide sample region and introduce illumination at one end of the capillary waveguide sample region and collect light at the opposite end for coupling to the detection means. In an alternate embodiment the entire sample path can be used to both guide and analyze the light, either in a straight path or in a curved path. See drawing FIG. 2.

A wide range of methods can be used to introduce the sample into the capillary waveguide region such as suction, pressurized injection, capillary flow, electro-osmotic flow, electro-wetting and other passive or active means. The invention can be adapted to directly couple to a device used for loading a sample with a suction means such as a syringe, pipette, squeeze bulb or a pump. The invention can also be used to directly couple to methods of sample introduction or incorporate the sample loading mechanism into the device.

One example is a device with a squeeze bulb that sucks a sample into the sample region. (See drawing FIG. 3.) Another example is an embodiment that uses a pipette to provide the suction which draws the sample into the sample region (not shown).

Mechanical and optical coupling to a light source and a light detection device, such as a spectrometer, can be enabled with a variety of means including free space coupling, optical fiber coupling, lens coupling, diffractive optic coupling, non-lens light concentrator or a similar means.

Referring now to the figures, a simplified version of the invention is shown in FIG. 1. In this embodiment a fluid filled sample region 90 extends from the illumination input adaptor region 50 to the detector connection adaptor region 55, bypassing the need for light guides as shown in other embodiments of this invention. The illumination input and detector connection adaptors 50 and 55 are fabricated to have recesses that match the instrument for which it is adapted. In this drawing the adaptors 50 and 55 will mechanically and optically couple to the fiber ferrule of the upper arm assembly and lower pedestal respectively of a NanoDrop spectrophotometer. Other instruments could have different shapes for these adaptor regions.

The sample is introduced into the capillary waveguide sample region 90 through the sample orifice 51. The input adaptor 50, the orifices 51 and 53, the sample region 90 and the detector connection 55 benefit from having a hydrophobic surface so that there is a small wetted area at the optical point of contact between the device and the instrument it is adapted to.

When used for absorption measurements, the illumination light propagates from the input adaptor 50 through the sample region 90 and couples into a light measuring instrument via the detector connection adaptor 55. In other modes of analysis these structural elements perform in a similar manner such as coupling fluorescence or Raman excitation light into the sample with input adaptor 50 and providing a connection 55 to enable detection and measurement of the resulting fluorescence or Raman shifted signal.

FIG. 1A shows a sample region 90 with a series of smooth curves that extend the path taken by the illumination propagating through the sample 93 between the input 50 and the detector adaptor 55. FIG. 1E has the same basic characteristics but uses straight channel segments for guiding the illumination with reflective surfaces 100 that allow tighter turns and potentially longer path lengths in a given size device as shown in FIG. 1D. These paths are shown as hollow capillaries and hollow channels in the body of the device 1. As shown in FIG. 1B and FIG. 1C, the cross section of the sample regions can be circular 91 or rectangular 95 as well as other shapes. If they are fabricated as a depression or channel in sections 111 of the device body 1 they may be fused or glued together or to a cover piece without channels 110 along the parting line 130. The body 1 may be fabricated from a low index material such as Teflon AF, or alternatively a layer 140 of a low index material can be coated on to the top and bottom sections of the block prior to them being joined. If a low index material such as Teflon AF is used for the coating 140 then the process of joining the two sections is facilitated by using heat to melt the two coatings together to produce a permanent seal. Drawing dimensions are not to scale and the location and orientation of components is not specific to any particular side or edge of the device.

FIG. 2 is the layout of another embodiment of the invention which uses light guides 70 and 75 to carry illumination entering the device through input adapter 50 to the sample region 90 then through the sample 93 to the detector connection 55. Surrounding the sample region is a low index cladding 95 which guides the illumination through the sample 93 which is introduced into the substantially hollow sample region 90 through the sample port 10 and sample channel 11 while any air in the sample region is expelled through port 30, which may also be utilized to draw a sample into the sample region using suction. A thin coating 99 may be placed on the interior surface of the sample region in order to bind specific components in the sample. FIG. 2B is an expanded view of the sample region structure. Drawing Dimensions<>are not to scale and the location and orientation of surface components is not specific to any particular side or edge of the device.

FIG. 3 shows a version of the same embodiment as in FIG. 2 with an integrated squeeze activated suction bulb composed of a flexible membrane 150 that can°>be pressed into pocket 160 to draw through suction channel 155 and draw a sample 93 in to the sample chamber 90. This embodiment has tube 13 protruding from the device and communicating with the sample chamber through the sample channel 11 for the purposes of approaching samples that are in recess such as a multiwell assay plate or a microarray slide. The drawing dimensions are not to scale and the location and orientation of surface components is not specific to any particular side or edge of the device.

The functional concept of the invention is to use the light propagating through a waveguide to optically probe a small sample place there in and measure specific characteristics of the sample as a method of analysis. The utility of the device is that it enables the examination and measurement of relevant characteristics of small samples and applications of the invention range broadly, everything from DNA analysis and environmental monitoring to the real-time examination of single cell metabolism.

For purposes of loading a liquid sample into the waveguide it is configured as a capillary tube with a length substantially greater than its diameter. In order to have improved capillary draw of a sample, the interior surface of the capillary waveguide can be chemically or mechanically treated in order to make it hydrophilic, i.e. oxygen plasma treatment, and coatings can be placed on this surface to enhance the performance of the waveguide such as a reflective layer, a light frequency selective layer or it can be treated to enhance sample interaction such as a coating that is selective to specific molecules, i.e. certain nucleic acids, or the shape or orientations of specific molecules, i.e. functional components of enzymes or sequences of specific DNA molecules.

The sample can be a liquid, gel, gas or other substance which allows the light to traverse the length of the waveguide while having an interaction with it. An illumination source is placed at one end of the capillary waveguide and a light detection means is placed at the other end in order to facilitate measurement of the interaction of the light entering the waveguide with the sample inside the waveguide. In interacting with the light propagating in the waveguide, the contained sample can absorb, scatter, fluoresce, or generate specific wavelengths in response to the wavelength or intensity of the illumination or perform any of these functions in a manner that is selective spectrally or specific to the sample or the presence or concentration of a specific constituent of the sample.

The volume of the sample is characteristically between a few femtoliters and a few microliters. In one embodiment of the invention the capillary tube is less than 100 microns in diameter and the length is great than 1 mm.

The light source can be a narrow band source like a laser, tuned to a specific wavelength or wavelengths by spectrally selective means like a diffraction grating or an interference filter, or can be a broad band source like a xenon flash lamp. For applications that are specific to one wavelength of light, i.e. a molecular probe's (dye) fluorescence, the detector can be a single wavelength detector such as a photodiode or photomultiplier tube with a wavelength selective filter between it and the light exiting the waveguide. For spectroscopic applications, such as DNA quantitation, the detector can be a combination of a device for generating a spectrum of the light such as a diffraction grating, tunable filter or prism, and the detector can be a light sensitive device or medium such as a photodiode array, angle or position scanned photomultiplier, photographic film or other means of extracting spectrally resolved information from the light exiting the sample region.

One embodiment of the invention that is specific to small samples is a microfluidic chip, entirely fabricated from plastic and containing the following elements: a sample input port that leads to a 100 micron diameter by 10 mm long Teflon AF lined capillary region, a means to allow air to exit the capillary as the sample enters, an input lightguide for bringing illumination to the one end of the capillary, an output lightguide that collects light at the opposite end of the capillary and a means to couple to the two lightguides respectively to a source of illumination and a light detector.

In this embodiment the lightguides need not be collinear or coaxial with the capillary since they can route light around a tight radius.

What is claimed is:

1. A cuvette where the sample contained in a capillary waveguide sample region.

2. Claim 1 where the method of introducing a sample into the sample region.

3. Claim 1 where the method to couple the illumination light into the capillary waveguide is fiber optics, lens, ball lens, diffraction grating, or concentrator.

4. Cuvette of claim 1 where the means of coupling the light from the capillary waveguide to a detector is an optical waveguide, fiber optics, lens, ball lens, diffraction grating, or concentrator.

5. The cuvette of claim 1 where there is provided means to optically couple the device to an instrument such as a spectrometer.

6. The cuvette of claim 4 is a fiber optic ferrule

7. The method of manufacturing a cuvette of claim 1 by subtractive manufacturing such as mechanical milling, laser milling or etching.

8. The method of forming a micro cuvette using 3D printing.

9. The method of claim 7 by co-molding in two or more plastics or a combination of glass, plastic or other materials.
